(19) United States
(12) Patent Application Publication
(10) Pub. No.: US 2026/0064708 A1
(43) Pub. Date: Mar. 5, 2026

(54) RANKING ITEM OBJECTS

(71) Applicant: Walmart Apollo, LLC, Bentonville, AR (US)

(72) Inventors: Yijie Sun, Santa Clara, CA (US); Chittaranjan Tripathy, Sunnyvale, CA (US); Asheem Sinha, Fremont, CA (US); Nita Himanshu Malani, Thornhill (CA); He Wen, Menlo Park, CA (US)

(21) Appl. No.: 19/314,576

(22) Filed: Aug. 29, 2025

Related U.S. Application Data
(60) Provisional application No. 63/689,063, filed on Aug. 30, 2024.

(51) Int. Cl. G06F 16/248; G06Q 30/0601

(52) U.S. Cl. CPC G06F 16/248; G06Q 30/0603

(57) ABSTRACT

Examples relate to ranking item objects based on a query. An example includes receiving a query including a plurality of tokens, selecting at least one or more item objects including item object titles, ranking the one or more item objects using a ranking module, scoring each respective selected item object title and the query using a discriminative text module, receiving the scores for at least two categories for the one or more item object titles and the query, and applying a trained machine learning model to the query, the titles of each of the one or more item objects and the feature data for each respective item object of the one or more item objects, such that the trained machine learning model outputs an evaluation of the scores of the one or more item objects selected for the query.

### CROSS REFERENCE TO RELATED APPLICATION

This application claims benefit to U.S. Provisional Patent Application No. 63/689,063, entitled “RANKING ITEM OBJECTS,” filed on Aug. 30, 2024, the disclosure of which is incorporated herein by reference in its entirety.

### TECHNICAL FIELD

This application relates generally to generation of user interfaces, and more particularly, to selecting and ranking interface objects based on query understanding.

### BACKGROUND

Users may input longer queries into a search field to convey specificity when performing a catalog search for one or more products. Some methods of item retrieval based on the query include identifying all catalog products that match with any of the words entered into the product search field. Such methods may result in recalling multiple irrelevant items in the catalog that may or may not be similar to the specific items the user is looking for. The inclusion of irrelevant search matches may cause methods of item ranking to subsequently display irrelevant results at the top of the user interfaces, despite the target items existing in the selected set of item objects retrieved from the catalog.

### SUMMARY

In various embodiments, a system is disclosed. The system includes a non-transitory memory having instructions stored thereon and a processor configured to read the instructions to receive a query including a plurality of tokens and select at least one or more item objects. Each respective selected item object has a respective item object title. The processor is further configured to receive features data from a features database and rank the one or more item objects using a ranking module. The ranking module facilitates the ranking by configuring the processor to score each respective selected item object title and the query using a discriminative text module. The discriminative text module facilitates the scoring by configuring the processor to perform one or more processes on the query and item object titles configured to create a modified query and modified item object titles and score each respective modified item object title and the modified query in at least two categories. The processor is further configured to receive the scores for the at least two categories for the one or more modified item object titles and the modified query, and apply a trained machine learning model to the modified query, the modified titles of each of the one or more item objects and the feature data for each respective item object of the one or more item objects, such that the trained machine learning model is configured to output an evaluation of the scores of the one or more item objects selected for the query.

In various embodiments, a computer implemented method is disclosed. The computer implemented method includes the steps of receiving a query including a plurality of tokens and selecting at least one or more item objects. Each respective selected item object has a respective item object title. The method further includes receiving features data from a features database and ranking the one or more item objects using a ranking module. The ranking module facilitates the ranking by scoring each respective selected item object title and the query using a discriminative text module. The discriminative text module facilitates the scoring by performing one or more processes on the query and item object titles configured to create a modified query and modified item object titles and scoring each respective modified item object title and the modified query in at least two categories. The method further includes receiving the scores for the at least two categories for the one or more modified item object titles and the modified query, and applying a trained machine learning model to the modified query, the modified titles of each of the one or more item objects and the feature data for each respective item object of the one or more item objects, such that the trained machine learning model is configured to output an evaluation of the scores of the one or more item objects selected for the query.

In various embodiments, a non-transitory computer readable medium having executable instructions stored thereon is disclosed. When the executable instructions are executed by one or more processors of a computing device, the instructions cause the one or more processors to receive a query including a plurality of tokens and select at least one or more item objects. Each respective selected item object has a respective item object title. The instructions further cause the processor to receive features data from a features database and rank the one or more item objects using a ranking module. The ranking module facilitates the ranking by configuring the processors to score each respective selected item object title and the query using a discriminative text module. The discriminative text module facilitates the scoring by configuring the processors to perform one or more processes on the query and item object titles configured to create a modified query and modified item object and score each respective modified item object title and the modified query in at least two categories. The instructions further cause the processor to receive the scores for the at least two categories for the one or more modified item object titles and the modified query and apply a trained machine learning model to the modified query, the modified titles of each of the one or more item objects and the feature data for each respective item object of the one or more item objects, such that the trained machine learning model is configured to output an evaluation of the scores of the one or more items selected for the query.

### BRIEF DESCRIPTION OF THE DRAWINGS

Various examples will be described by the following detailed description of the preferred embodiments, which is to be considered together with the accompanying drawings wherein like numbers refer to like parts and further wherein:

FIG. 1 illustrates a network environment configured to generate and rank item objects based on a query, in accordance with some embodiments;

FIG. 2 illustrates a computer system configured to implement one or more processes, in accordance with some embodiments;

FIG. 3 is a flowchart illustrating an item object generation and ranking method, in accordance with some embodiments;

FIG. 4A is a process flow illustrating various steps of the item object generation and ranking method of FIG. 3, in accordance with some embodiments;

FIG. 4B is an example training timeline, in accordance with some embodiments;

FIG. 5 is a process flow illustrating a method of training the machine learning model used in the item object generation and ranking method in FIG. 3, in accordance with some embodiments;

FIG. 6 illustrates various equations that may be used in one or more of the steps in FIG. 3, FIG. 4A and FIG. 5, in some embodiments;

FIG. 7 illustrates an artificial neural network, in accordance with some embodiments;

FIG. 8 illustrates a tree-based artificial neural network, in accordance with some embodiments;

FIG. 9 illustrates a deep neural network (DNN), in accordance with some embodiments;

FIG. 10 is a flowchart illustrating a training method for generating a trained machine learning model, in accordance with some embodiments; and

FIG. 11 is a process flow illustrating various steps of the training method of FIG. 10, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating one or more user interface elements based on matching one or more words in a query to the titles of the one or more user interface elements. In various embodiments, generating and ranking item objects includes receiving a query including a plurality of tokens (e.g., words) and selecting at least one or more item objects. Each respective selected item object has a respective item object title. Features data is received from a features database and one or more item objects are ranked using a ranking module. The ranking module facilitates the ranking by scoring each respective selected item object title and the query using a discriminative text module. The discriminative text module facilitates the scoring by performing one or more processes on the query and item object titles configured to create a modified query and modified item object titles and scoring each respective modified item object title and the modified query in at least two categories. Scores are received for the at least two categories for the one or more modified item object titles and the modified query, and applying a trained machine learning model to the modified query, the modified titles of each of the one or more item objects and the feature data for each respective item object of the one or more item objects, such that the trained machine learning model is configured to output an evaluation of the scores of the one or more item objects selected for the query. The disclosed systems and methods address the problem of irrelevant search results being retrieved due to large queries and irrelevant items being ranked highly for display to a user. The disclosed systems and methods provide an improvement over existing search and ranking systems by reducing resources required to implement searches (e.g., by providing only relevant results in an initial search to reduce a number of searches required to identify relevant items, by targeting relevant terms in large queries and reducing computational resources for each search, by ranking only relevant items responsive to large search queries, etc.)

In some embodiments, systems, and methods for item object generation and ranking includes one or more trained machine learning models. The trained machine learning models may include one or more models, such as trained causal inferencing models, deep neural networks, etc. As one example, a trained causal inferencing model may be configured to utilize one or more causal inferencing techniques to identify, rank, and/or otherwise select item objects from a set of item objects for presentation in a specific order on a user interface.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

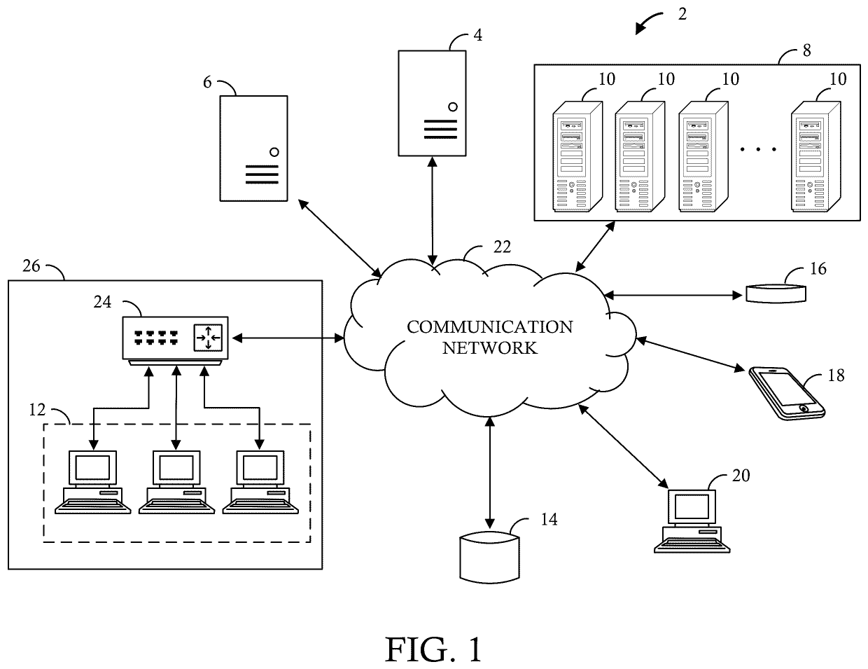

FIG. 1 illustrates a network environment 2 configured to provide item object generation and ranking, in accordance with some embodiments. The network environment 2 includes a plurality of devices or systems configured to communicate over one or more network channels, illustrated as a network cloud 22. For example, in various embodiments, the network environment 2 may include, but is not limited to, an item object generation and ranking computing device 4, a web server 6, a cloud-based engine 8 including one or more processing devices 10, a database 14, and/or one or more user computing devices 16, 18, 20 operatively coupled over the network 22. The item object generation and ranking computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the item object generation and ranking computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the item object generation and ranking computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the item object generation and ranking computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the item object generation and ranking computing device 4, for example. The workstation(s) 12 may communicate with the item object generation and ranking computing device 4 over the communication network 22. The workstation(s) 12 may send data to, and receive data from, the item object generation and ranking computing device 4. For example, the workstation(s) 12 may transmit data related to tracked operations performed at the physical location 26 to item object generation and ranking computing device 4.

Although FIG. 1 illustrates three user computing devices 16, 18, 20, the network environment 2 may include any number of user computing devices 16, 18, 20. Similarly, the network environment 2 may include any number of the item object generation and ranking computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the item object generation and ranking computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the item object generation and ranking computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the item object generation and ranking computing device 4.

In some embodiments, the item object generation and ranking computing device 4 may execute one or more models, processes, or algorithms, such as a machine learning model, deep learning model, statistical model, etc., to generate and rank the item objects. The item object generation and ranking computing device 4 may transmit generated and ranked item objects to the web server 6 over the communication network 22, and the web server 6 may display interface elements associated with the generated and ranked item objects on the website to the user. For example, the web server 6 may display interface elements associated with item object generation and ranking to the user on a homepage, a catalog webpage, an item webpage, a window or interface of a chatbot, a search results webpage, or a post-transaction webpage of the website (e.g., as the user browses those respective webpages).

In some embodiments, the web server 6 transmits an item object generation and ranking request to the item object generation and ranking computing device 4. The item object generation and ranking request may be a request for an interface such as ranked item objects related to a specified entered query.

In some embodiments, a user submits a query on a website hosted by the web server 6. The web server 6 may send an item object generation and ranking request to the item object generation and ranking computing device 4. In response to receiving the item object generation and ranking request, the item object generation and ranking computing device 4 may execute one or more processes to determine item object generation and ranking and transmit the results including item object generation and ranking to the web server 6 to be displayed to the user.

The item object generation and ranking computing device 4 is further operable to communicate with the database 14 over the communication network 22. For example, the item object generation and ranking computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the item object generation and ranking computing device 4, in some embodiments, the database 14 may be a local storage device, such as a hard drive, a non-volatile memory, or a USB stick. The item object generation and ranking computing device 4 may store interaction data received from the web server 6 in the database 14. The item object generation and ranking computing device 4 may also receive from the web server 6 user session data identifying events associated with browsing sessions, and may store the user session data in the database 14.

In some embodiments, the item object generation and ranking computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The item object generation and ranking computing device 4 and/or one or more of the processing devices 10 may train one or more models based on corresponding training data. The item object generation and ranking computing device 4 may store the models in a database, such as in the database 14 (e.g., a cloud storage database).

The models, when executed by the item object generation and ranking computing device 4, allow the item object generation and ranking computing device 4 to identify item objects for presentation via a user interface. For example, the item object generation and ranking computing device 4 may obtain one or more models from the database 14. The item object generation and ranking computing device 4 may then receive, in real-time from the web server 6, a request for one or more item objects related to an input query. In response to receiving the request, the item object generation and ranking computing device 4 may execute one or more models for item object generation and ranking.

In some embodiments, the item object generation and ranking computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, item object generation and ranking computing device 4 may generate item object generation and ranking.

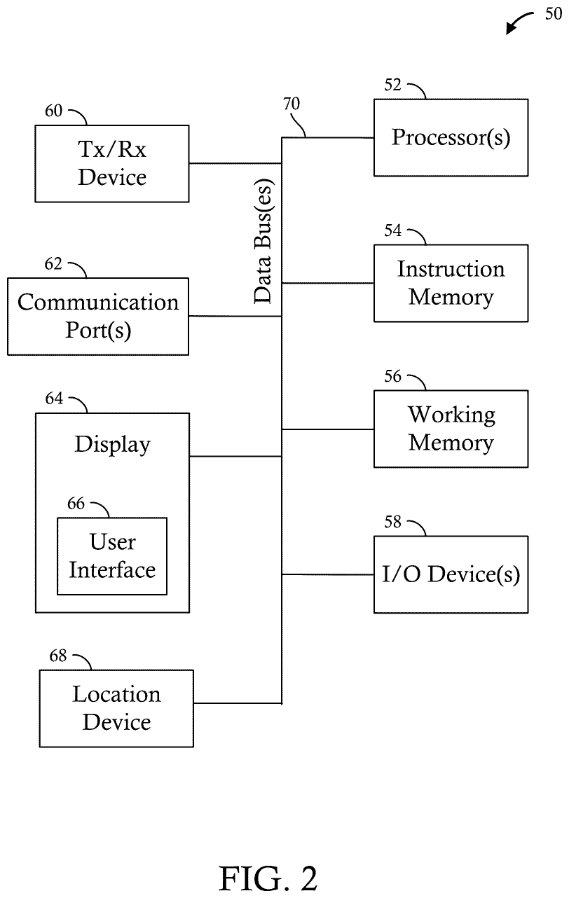

FIG. 2 illustrates a block diagram of a computing device 50, in accordance with some embodiments. In some embodiments, each of the item object generation and ranking computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for item object generation and ranking, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allows for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with item object generation and ranking. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

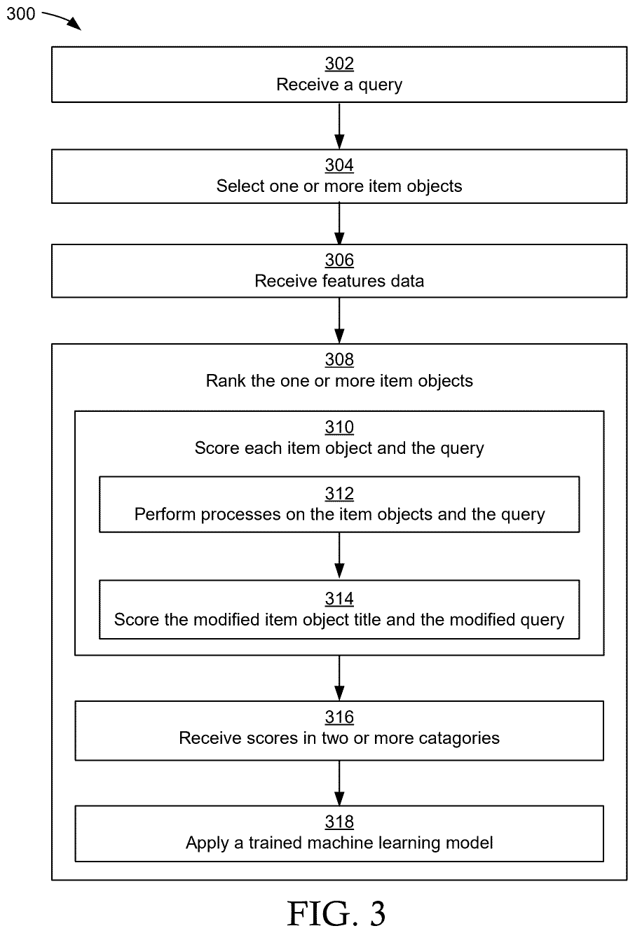

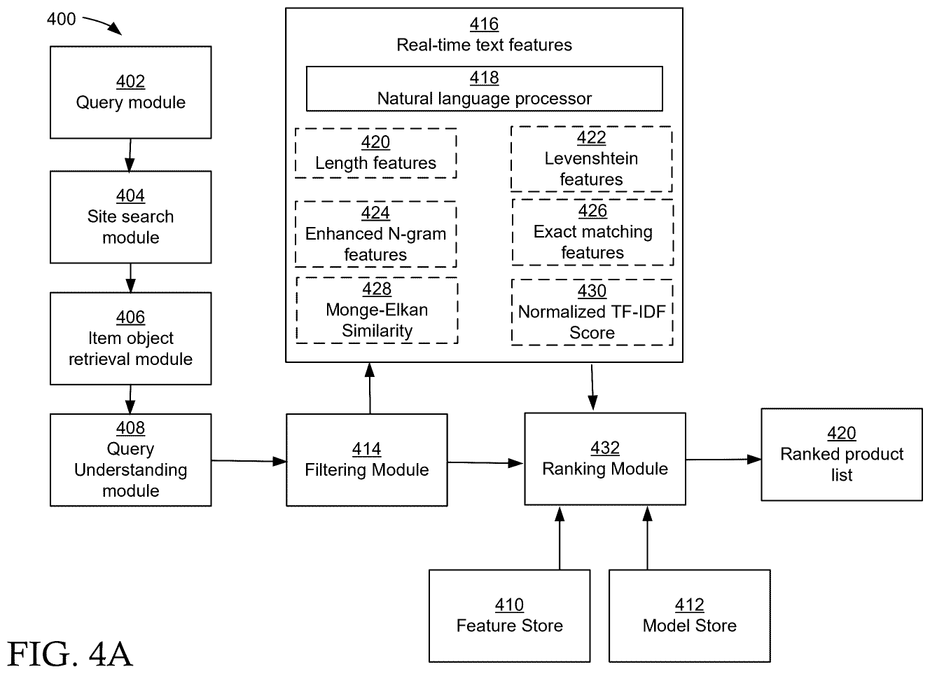

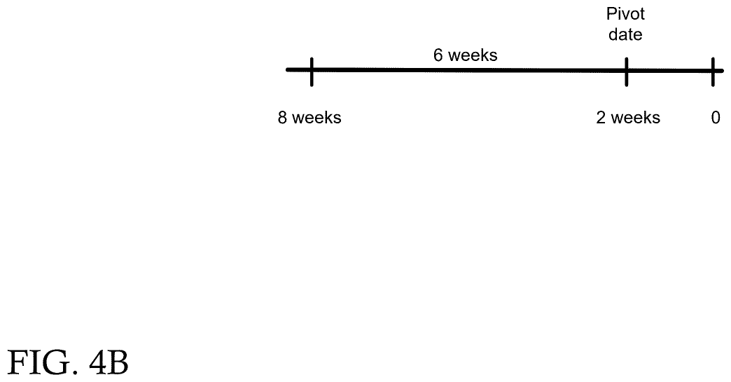

FIG. 3 is a flowchart illustrating an item object generation and ranking method 300, in accordance with some embodiments. FIG. 4A is a process flow 400 illustrating various steps of the item object generation and ranking method 300, in accordance with some embodiments. The item object generation and ranking method 300 is configured to generate instructions to cause a device to display one or more item objects related to a search query provided by a user. The item object generation and ranking method 300 may be implemented by any suitable system, such as, for example the interface generation computing device 4 discussed above. Although embodiments are discussed herein including application of certain steps and/or processes, it will be appreciated that various elements of the item object generation and ranking method 300 may be performed in various orders and/or performed by additional and/or alternative processes or system elements as those disclosed herein.

The item object generation and ranking method 300 incorporates a diverse set of text features into the ranking module such that the ranking module scores the most relevant item objects higher even when engagement data is sparse. The item object generation and ranking method 300 may thus reduce user frustration, lower the number of abandoned searches, and lead to higher conversion rates and improved search engagement by prioritizing relevant item objects. Furthermore, the query entered into the search area on the user interface is used as the anchor and the ranking module may find as close of a match as possible between the query and the title of one or more item objects such that more weight is given to the words entered into the search.

At step 302, a query is received. In some embodiments, the query includes a plurality of words (e.g., tokens) and is received from a user. For example, the query is entered into a search area of a user interface configured to search for item objects. The more words the query contains the more specific the item objects being searched. For example, a user searching for an “organic gala apple” will likely use the entire phrase versus just typing “apple.” Queries are received and/or stored at the query module 402. In some embodiments, the query length conveys the level of specificity to which the user is searching for an item object.

At step 304, one or more item objects are selected. In some embodiments, one or more item objects are stored in an item object database and based on the query received at step 302, one or more item objects are selected. In some embodiments, item objects can include items in an e-commerce catalog. Each respective item object includes an item object title, and the one or more object items may be selected based on the relevance of their title to the query. For example, relevance may include if the one or more of the words in the item object titles are associated with at least one or more words in the query. Association may include words that have a similar or the same semantic meaning to the words in the query but not necessarily including the exact same word (e.g., bath tissue and toilet paper). The site search module 404 receives the query from step 302 to determine one or more relevant item objects in the item object database. The item object retrieval module 406 then retrieves a subset of the relevant item objects to the query including item object metadata. In some embodiments, the item object retrieval module 406 retrieves 200+ item objects.

At step 306, features data is received. In some embodiments, the features data is retrieved from a features database and/or from the features store 410. The features data includes historical data and query understanding signals. The query understanding signals are produced from the query understanding module 408 and historical data includes engagement signals from one or more users. For example, product metadata includes pricing, ratings, and/or availability for each of the respective one or more item objects. Engagement signals include data such as the click through rate (CTR), the add to cart (ATC) rate and the order rate that are computed for item object, the leaf category of the item object, and the item brand. The query understanding signals, generated by the query understanding module 408, includes upstream brand extraction algorithms, department classifications, and fine line category classifications.

At step 308, the one or more item objects (i.e., those selected at step 304) are ranked. In some embodiments, the one or more item objects are ranked by a ranking module 432 based on their item objects titles relevance to the query via the ranking module 432. The ranking module 432 is configured to receive the historical data, query understanding signals, real-time text features, and scores based on the concatenation of the query and item object titles and to output a ranked list of item objects most relevant to the query.

At step 310, each item object and the query are scored. In some embodiments, a discriminative text module is used to score the one or more item object titles based on the query. The scoring process is further described below.

At step 312, processes are performed on the item objects and the query. For example, the query and each respective selected item object title is processed using a natural language processor 418 to create a modified query and modified object item titles. For example, the modified query and modified object item titles are put into canonical forms to make scoring and ranking processing more accurate. Raw queries are often messy with variations in spelling, grammar, word choice, word order, etc. Therefore, the words in the query and item object titles may be tokenized, normalized, and lemmatized using pre-trained models. Additionally, accents on letters and stop words are removed. For example, in countries that have languages with accents (e.g., France, Canada, etc.) the accents are removed to normalize the words to ensure a more accurate evaluation. In some embodiments, modules 420-430 receive the modified item object titles and the modified query output from the natural language processor 418.

At step 314, the modified item object title and the modified query are scored. For example, each respective item object title and modified query may be scored in at least two categories described below. The categories may include methods of discriminative text signals.

### Distance at the Sub Word/String Level

One category includes length features processed by the length features module 420. While traditional methods look at the word count of the query and the item object title separately, the length features module 420 introduces additional features that look at the difference in sub-word token count and/or string length between the query and the item object title. Another category includes Levenshtein features evaluated by the Levenshtein features module 422 which supplements the length features by evaluating a per character Levenshtein distance which normalizes the edit distance by the string length of the query. The normalized Levenshtein similarity score evaluates the query and object item title such that a higher similarity results in a higher score.

### Asymmetrical Matching

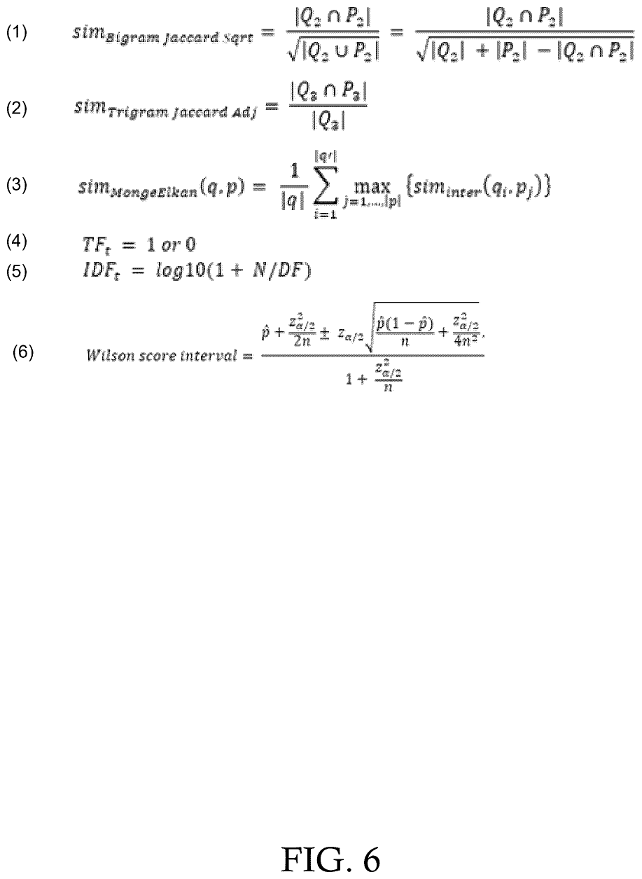

Another category includes asymmetrical matching using the query as an anchor. This asymmetrical matching matches the words in the query with the words in the item object title to determine if the query words can be satisfied by the words in the product title including determining enhanced N-gram character-based and token-based Jaccard features which are produced by transforming the denominator of equation (1) shown in FIG. 6 including taking the square root of the number of N-grams in the union or dividing by the number of N-grams in the query only. In some embodiments, the N-gram character based and token-based Jaccard features are generated using the enhanced N-gram features module 424. Qₙ and Pₙ are the set of N-grams constructed respectively from the modified query (q) and the modified item object title (p). Where ∥ denotes the set cardinality (i.e. the number of N-grams). Both adjustments may outperform the regular definition in computing the N-gram character-based and token-based Jaccard similarity in situations where the item object titles are long and contain extra information compared to the query.

Another category includes asymmetrical matching using Monge-Elkan similarity. The Levenshtein features evaluate string-level matches, however the Monge-Elken similarity module 428 evaluates the modified query and modified item object titles by splitting the query into tokens for analysis. For example, Monge-Elkan similarity iterates over the tokens in the query (q) looking for the most similar word in the item object title (p) as judged by an inter-word similarity measure such as the Levenshtein similarity. Equation (3) shown in FIG. 6 illustrates the process mathematically. This asymmetrical similarity measure matches as much of the query as possible from the item object title regardless of the unmatched tokens in the item object title. In some embodiments, simᵢₙₜₑᵣ is the Levenshtein similarity, qᵢ′ and denotes the i^{th} token in q′ (modified query) and pⱼ′ denotes the j^{th} token in p′ (modified item object title). In addition to performing asymmetrical matching, the Monge-Elkan similarity is also invariant to word permutation. This feature is valuable because users tend not to type queries in the natural language order (e.g., “women jeans” vs “jeans women”) but are still valid queries and appear frequently across search sessions.

### Exact Matching Features

Another category includes exact matching features which analyzes the number of words matching to look for overlapping words aiming to quantify the match at the word level. In some embodiments, the exact matching features methods below are processed by the exact matching features module 426. For example, a larger number/percentage of common words between the query and the item object title indicates a higher level of relevance and confidence the exact item object matches the query. In other words, when a user types a long query indicating a specific object item they are looking for, more individual words matched may yield a better chance the item object associated with the item object title is the one the user is searching for. Calculating the number of exact match words, the percentage of query words matched, and the percentage of object item words matched disentangle the effect of having a longer query versus a longer item object title. Thus, the number and percentage of exact word matches between the query and the item object title is determined in addition to the interaction match query (number of exact word matches multiplied by the percentage of word match in the query) and interaction percent match (percent of the token matched in the query multiplied by the percentage word match in the product title).

The exact matching features are represented with two second order interactions. The interaction match query accounts for the difficulty of matching a narrow query such that the interaction query match is designed to take the product of the number of exact words matched and the percentage of query words matched. The interaction percent match introduces a minor penalty under equal percentage of query words matched to differentiate cases where a shorter item object title should be considered a better match. For example, if the query is “laptop” and two object item titles “laptop” and “laptop adaptor” appear, although they both have the same number of query words matched, the “laptop” item object title has a 100% match versus a 50% match for “laptop adaptor” and thus should be ranked higher. Additionally, an interaction percentage match is equal to the percentage of query words matched multiplied by the percentage of item object words matched. In this equation, all of the words in the query and the item object title are weighed equally. In some embodiments, the words in the query and the item object titles may be weighed differently.

Rarer words in the query are more likely to be the distinguishing factor for determining product relevance. Thus, the normalized TF-IDF score is determined using a weighting strategy that incorporates all the item objects during the site search module 404 and the item object retrieval module 406 retrievals. In some embodiments, the normalized TF-IDF score is generated using the Normalized TF-IDF score module 430z. In some embodiments, the query and the item object titles may include duplicate words which might increase the scores in other categories but does not necessarily ensure a better match between the query and the item object titles. For example, item object titles may contain duplicated copies of matching terms, however three redundance occurrences does not necessarily make it a better match than an item object title containing a single instance of the term. Thus, Boolean term frequency with an inverse document frequency is used and represented in equations (4) and (5) shown in FIG. 6. In equations (4) and (5) t represents any word in query q, N is the total number of products in the recall set, and DF represents the number of products containing word t. After summing up the TF-IDF score over the words in the query, the cosine normalization is performed using the square root of the length of the item object title.

Additional text features include indexing of the matching words and matching continuity scores. Motivated by the observation that the initial words of the item object title tend to convey the chief function of the item object type, we create a feature to track the starting index of the matched tokens, and we consider matching at the beginning of the item object title to be more reliable than matching at the end. Furthermore, we design a matching contiguity score to compute summary statistics (e.g., average, standard deviation, range) over the indices of the matched tokens. If the words in query q appear contiguously in item object title p following the same order, then we have a higher confidence of the match. Additionally, summary statistics are computed using the indices average, standard deviation, and range. In some embodiments, the additional text features are computed by the real-time text features module 416.

At step 316, scores in two or more categories are received. For example, scores for the one or more modified item object titles and the modified query are received. In some embodiments, the categories include scores generated by the real-time text features module 416, the natural language processor module 418, the length features module 420, the Levenshtein features module 422, the enhanced N-gram features module 424, the exact matching features module 426, the Monge-Elkan similarity module 428, and/or the normalized TF-IDF score module 430.

At step 318, a trained machine learning model is applied. In some embodiments, the real-time text features module 416 includes a ranking module that is the trained machine learning model. In some embodiments, the ranking module 432 is separate from the real-time text features module 416. In some embodiments, the applied trained machine learning model receives one or more inputs including the modified query, the titles of each of the one or more item objects, and the feature data for each respective item object of the one or more item objects and outputs an evaluation of the scores of the one or more item objects selected for the query. The scores are ranked with the highest score corresponding to the most relevant item object to the query. In some embodiments, the list of ranked item objects with the most relevant item objects appearing at the top are displayed on a user interface for the user. Additionally, the ranking module is also configured to receive the features data including historical data and engagement data from the feature store 410, and the query understanding signals from the query understanding module 408. Furthermore, the ranking module 432 receives one or more cached trained machine learning models from the model store 412.

In accordance with a determination that the ranked item objects will be displayed, the item object position is determined based on their rank. For example, for any item object (p), the position of the item object on the results page which is returned after the query is received from a user, is determined by the trained machine learning model which predicts a score given the feature values. In some embodiments, the ranking module 432 includes a trained gradient boosting algorithm with hyperparameter tuning, instance-weighting, feature-weighting, and early stopping. In some embodiments, instance weighting provides a greater weighting to a specific query item object pair that occur more often in past search data than another.

In some embodiments, as shown in FIG. 4B, the feature and target generation data for training is determined based on a time period. For example, the training data can include engagement data from the previous 6 weeks (e.g., prior to the pivot point) and the target calculations can include engagement data from the most recent non-overlapping 2 weeks (e.g., after the pivot point). Furthermore, the features generated from the engagement data may be cross-sectionalized to smaller time periods such as previous 1 week, 2 weeks, 3 weeks, 1 months, and 6 weeks measured backwards from the pivot date, i.e., date that separates the feature and target time horizons, usually taken to be the first day of target data generation date.

As illustrated in FIG. 4A, in accordance with a determination that a search is made in real time, the query passes through the site search module 404 and the item object retrieval module 406. The filtering module 414 receives the features data including historical data, engagement data from the feature store 410, and the query understanding signals from the query understanding module 408, and applies filtering rules on the set of item objects retrieved from the item object retrieval model based on the features data. In some embodiments, the filtering module 414 also has the product metadata retrieved from the item object retrieval module 406. The real-time text features module 416 loads features data and output from the filtering module 414, computes the text features in real time and applies the trained machine learning model from the model store 412. In some embodiments, the position of the item object on the result page is equal to the rank of the score predicted by the model based on the feature vector. In some embodiments, the operations performed in FIG. 4A are performed online.

The user features may include user preference data for a user based on attributes associated with that user. For example, the user preference data may identify and characterize attributes associated with a user during a browsing session of a website. In some examples, more than one attribute per attribute category (e.g., brand, type, description) may be identified. When generating user preference data for a user, the item object generation and ranking computing device 4 may determine, for each attribute category, an attribute that is identified most often (e.g., a majority attribute). The attribute defined most often in each attribute category is stored as part of the corresponding user preference data. In some examples, a percentage score is generated for each attribute within an attribute category, and the percentage score is stored as part of the user preference data. The percentage score is based on the number of times a particular attribute is identified in a corresponding attribute category with respect to the number of times any attribute is identified in that attribute category. In some examples, the item object generation and ranking computing device 4 stores the user preference data in database 14.

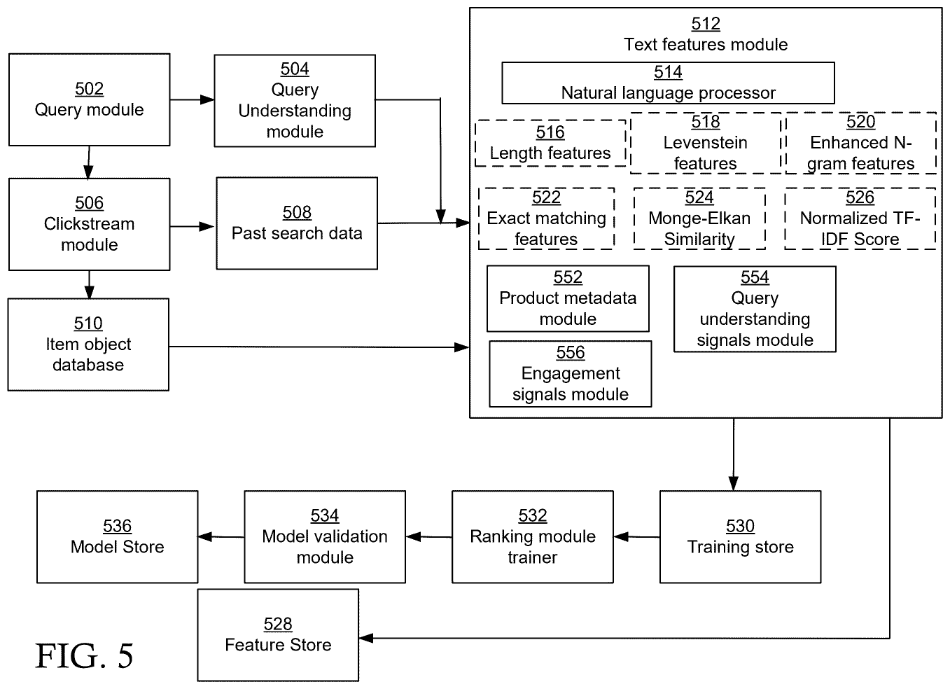

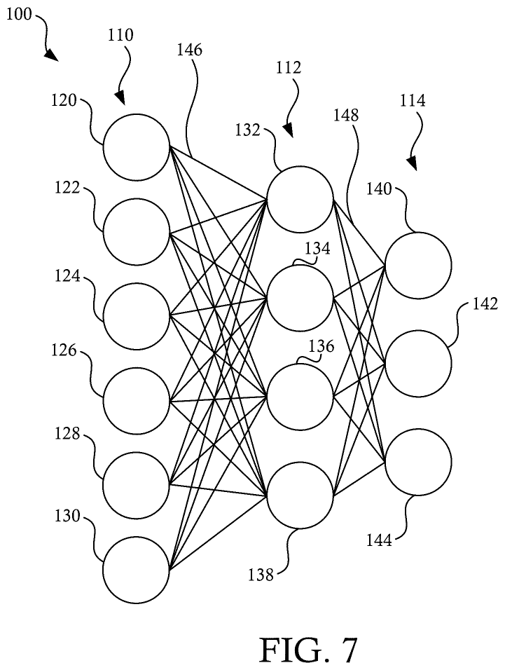

As shown in FIG. 5, in some embodiments, the trained machine learning model is configured to learn and optimize the respective importance of the text features along with the existing engagement, product metadata and query understanding features of the item objects. To train the machine learning model, the pointwise Learning-to-Rank (LETOR) objective is adopted where the target is a utility function combining the engagement within the most recent time period. In some embodiments, the utility function can be a weighted combination of the click through rate (CTR), the add to cart (ATC) rate and the order rate. Instead of using the raw engagement rates, the lowest bound of the 95% Wilson score interval is used to reduce the noise in the target. For a significance level a and an empirical success probability p\hat{ } with a total of n trials, the Wilson score interval is defined in equation (6). In equation (6), z represents the z-score of the normal distribution. In some embodiments, an Extreme Gradient Boosting (XGBoost) model is trained on the dataset with a 90%-10% train-test split. The model hyperparameters (such as number of estimators, max tree depth, learning rate, row and column sampling ratios) are finetuned using the offline Normalized Discounted Cumulative Gain (NDCG) score. In some embodiments, early stopping is applied to avoid overfitting. In some embodiments, the XGBoost model is trained using the artificial neural network, the tree-based artificial neural network, and/or the deep neural network described in FIGS. 7-9.

In some embodiments, process flows in FIG. 5 may include training the one or more models, producing the model store 536, and producing the feature store 528, which may be completed offline. The query module 502 includes analogous features to the query module 402 including storing one or more queries. The query understanding module 504 includes analogous features to the query understanding module 408. The clickstream module 506 includes user query information, product ID, and other features with respect to the clickstream pipelines. The past search data module 508 includes data representative of past search engagement such as when a user clicks on an item object that appears in a specific order of ranking, adds an item object to the cart, or orders an item object. The item object database 510 includes the available item objects to select from (e.g., a product catalog) including the item object title, price, ratings, availability, etc. The data from the query understanding module 504, the past search data 508, and the item object database 510 are received at the text features module 512 which includes analogous features to the real-time text features module 416. One or more modules included in the text features module 512 are used to train the ranking machine learning model including modules 514-526 which include analogous features to modules 418-430 in FIG. 4A. In some embodiments, the text features module 512 produces one or more signals including signals from the product metadata module 552, the query understanding signals module 554, the engagement signals module 556 and signals including data from modules 514-526. In some embodiments, the feature store 528 receives only signals from the engagement signals module and caches them to be used in online processes as illustrated in FIG. 4A. The produce metadata module 552 including pricing, ratings, and/or availability for each of the respective one or more item objects. The query understanding signals module 554 includes upstream brand extraction algorithms, department classifications, and fine line category classifications. The engagement signals module 556 includes data such as the click through rate (CTR), the add to cart (ATC) rate and the order rate that are computed for item object, the leaf category of the item object, and the item brand.

Identification of item object interface elements associated with item object generation and ranking can be burdensome and time consuming for users. Typically, a user may locate information regarding item object by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding the relevant item object interface elements. In other words, without the real-time/discriminative text features, irrelevant item objects could be ranked at the top of the search result page due to the sparsity of engagement data available for longer search queries. The output of the text features module 512 includes one or more features as output by modules 514-526 which are stored in the feature store 528. The feature store 528 in FIG. 5 is used in the feature store 410 in FIG. 4. The training store 530 includes stored features for every product pair sent through the text features module 512. The ranking module trainer 532 loads and trains the ranking modules. After the ranking module 432 is trained, it is validated by the model validation module 534 to ensure it is ready to be used in real-time calculations. If the ranking module is ready, it is stored in the model store 536 which is used in the model store 412 to support the completion of real-time calculations.

Systems including trained machine learning models, as disclosed herein, may significantly reduce this problem, allowing users to locate item objects with fewer, or in some cases, no active steps. For example, in some embodiments described herein, when a user is presented with item object interface elements, each interface element includes, or is in the form of, a link to an interface page for each respective item object. Each recommendation thus serves as a programmatically selected navigational shortcut to an interface page, allowing a user to bypass the navigational structure of the browse tree. Beneficially, programmatically identifying item object interface elements and presenting a user with navigations shortcuts to these tasks may improve the speed of the user's navigation through an electronic interface, rather than requiring the user to page through multiple other pages in order to locate the item object interface element via the browse tree or via a search function. This may be particularly beneficial for computing devices with small screens, where fewer interface elements are displayed to a user at a time and thus navigation of larger volumes of data is more difficult.

It will be appreciated that the scoring and ranking of item objects as disclosed herein, particularly on large datasets intended to be used to generate trained models used in the disclosed embodiments, is aided by computer-assisted machine-learning algorithms and techniques, such as the ranking machine learning model in the real-time text features module 416. In some embodiments, machine learning processes including the ranking machine learning model in the real-time text features module 416 are used to perform operations that cannot practically be performed by a human, either mentally or with assistance, such as item object generation and ranking. It will be appreciated that a variety of machine learning techniques can be used alone or in combination to generate and rank item objects.

FIG. 6 illustrates various equations that may be used in one or more of the steps in FIG. 3, FIG. 4A and FIG. 5, in some embodiments. Equations (1)-(6) are used in determining one or more discriminative text features and training the machine learning model as described in FIGS. 3-5.

FIG. 7 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 7 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{j}^{( n + 1 )} = f ( {\sum }_{i} {x}_{i}^{( n )} \cdot {w}_{i , j}^{( n )} )$$

denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weigh

$${w}_{i , j}^{( n , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on

$${δ}_{j}^{( n + 1 )} ,$$

if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and

$${y}_{j}^{( n + 1 )}$$

is the comparison training value for the j-th node of the output layer 114.

In some embodiments, the neural network 100 is configured, or trained, to generate and rank item objects.

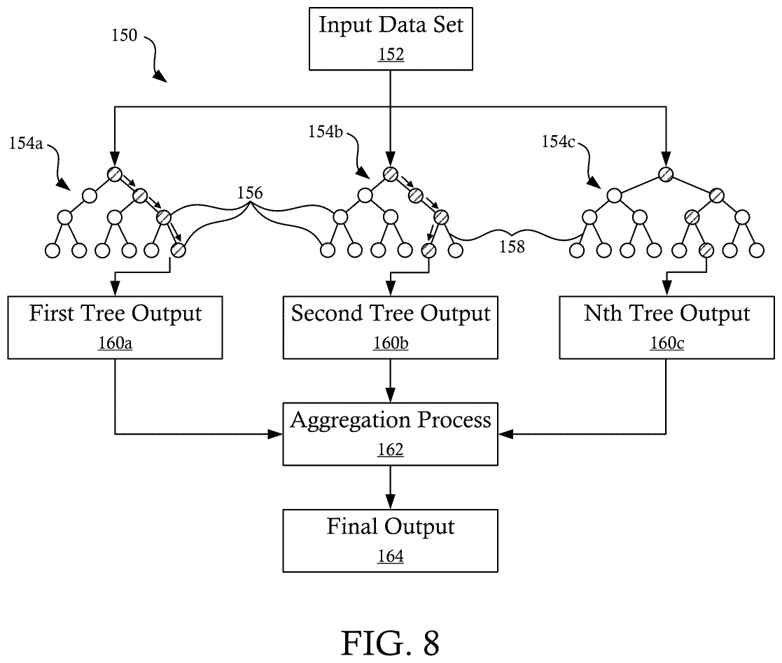

FIG. 8 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

In some embodiments, the tree-based neural network 150 is configured, or trained, to generate and rank item objects.

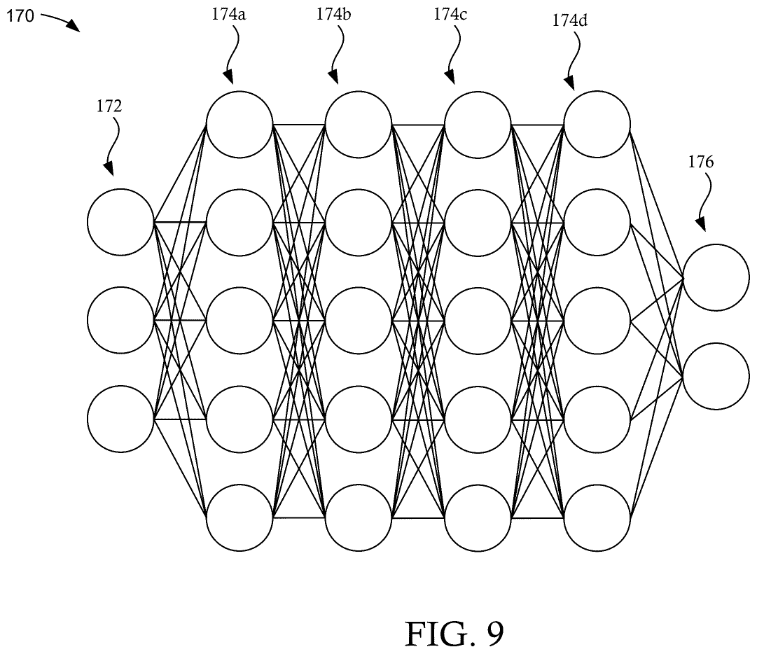

FIG. 9 illustrates a deep neural network (DNN) 170, in accordance with some embodiments. The DNN 170 is an artificial neural network, such as the neural network 100 illustrated in conjunction with FIG. 7, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

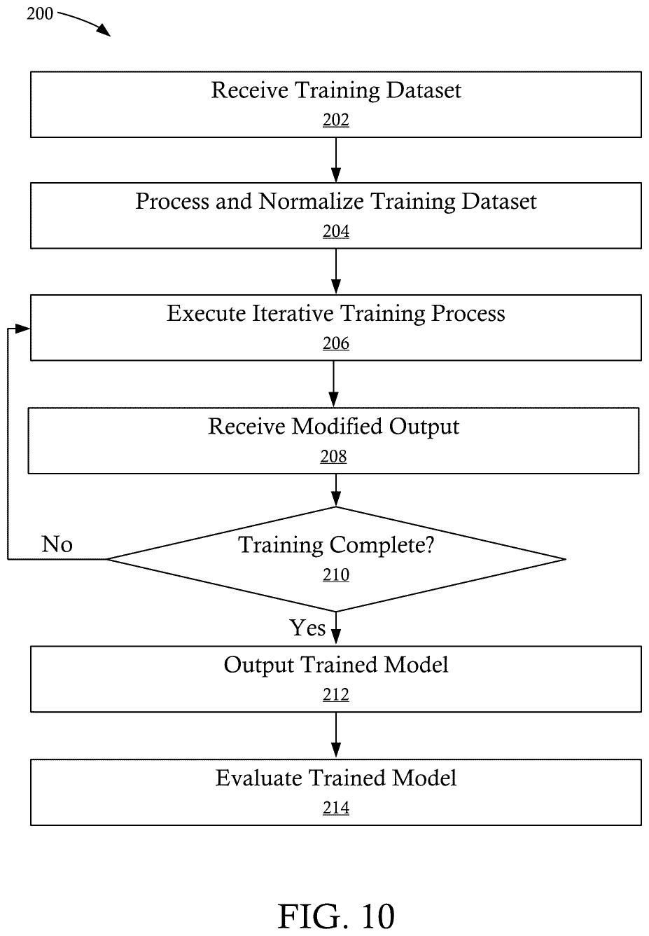

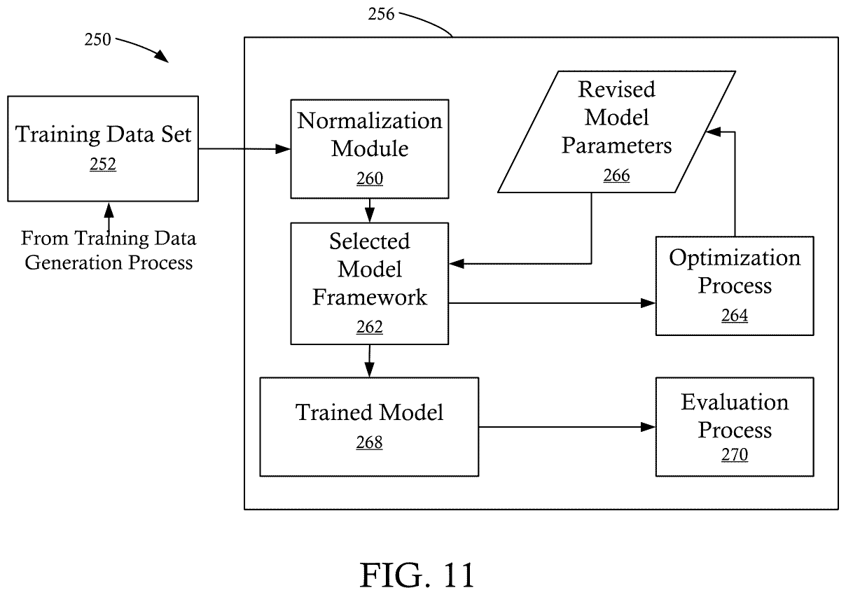

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x. In some embodiments, a ranking model can include and/or implement one or more trained models, such as a trained machine learning model. In some embodiments, one or more trained models can be generated using an iterative training process based on a training dataset. FIG. 10 illustrates a method 200 for generating a trained model, such as a trained optimization model, in accordance with some embodiments. FIG. 11 is a process flow 250 illustrating various steps of the method 200 of generating a trained model, in accordance with some embodiments. At step 202, a training dataset 252 is received by a system, such as a processing device 10. The training dataset 252 can include labeled and/or unlabeled data. For example, in some embodiments, discriminative text features, historical data, and query understanding signals are provided for use in training a model.

At optional step 204, the received training dataset 252 is processed and/or normalized by a normalization module 260. For example, in some embodiments, the training dataset 252 can be augmented by imputing or estimating missing values of one or more features associated with ranking score. In some embodiments, processing of the received training dataset 252 includes outlier detection configured to remove data likely to skew training of a ranking module. In some embodiments, processing of the received training dataset 252 includes removing features that have limited value with respect to training of the ranking module.

At step 206, an iterative training process is executed to train a selected model framework 262. The selected model framework 262 can include an untrained (e.g., base) machine learning model, such as the ranking module and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the cost value is related to the output.

The training process is an iterative process that generates a set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process and after receiving a modified output at step 208, a determination is made at step 210 whether the training process is complete. The determination at step 210 can be based on any suitable parameters. For example, in some embodiments, a training process can be completed after a predetermined number of iterations. As another example, in some embodiments, a training process can be completed when it is determined that the cost function of the selected model framework 262 has reached a minimum, such as a local minimum and/or a global minimum.

At step 212, a trained model 268, such as a trained ranking machine learning model, is output and provided for use in the item object generation and ranking, such as the object generation and ranking method discussed above with respect to FIGS. 3-4. At optional step 214, a trained model 268 can be evaluated by an evaluation process 270. A trained model can be evaluated based on any suitable metrics, such as, for example, an F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a processor; and
a non-transitory memory having instructions stored thereon that when executed by the processor, cause the processor to:
receive a query including a plurality of tokens;
select a plurality of item objects based on the query, wherein each item object of the plurality of item objects has a corresponding title;
obtain feature data of the plurality of item objects;
rank the plurality of item objects to generate a ranked list of item objects based at least by:
determining a plurality of text similarity metrics,
generating, for each item object having the corresponding title, similarity scores based on the plurality of text similarity metrics, respectively, wherein each of the similarity scores indicates a text similarity between the corresponding title and the query based on a respective one of the plurality of text similarity metrics, and
executing a machine learning model to the similarity scores of the plurality of item objects based on the feature data of the plurality of item objects to generate the ranked list of item objects; and
provide the ranked list of item objects in response to the query.

2. The system of claim 1, wherein the feature data of the plurality of item objects comprises at least one of:
product metadata including price, ratings, and availability for each of the plurality of item objects;
engagement data including click through rate (CTR), add to cart (ATC) rate and order rate (OR) for each item object, each leaf category of item objects, or each item brand; or
query understanding signals including brand extraction, department classification, and category classification of the plurality of item objects.

3. The system of claim 1, wherein generating the similarity scores comprises:
performing a plurality of natural language processes on the query and the corresponding title to create a modified query and a modified title, wherein the plurality of natural language processes comprise: tokenization, normalization, lemmatization, accent removal, and stop word removal; and
generating each of the similarity scores to represent a text similarity between the modified query and the modified title based on a respective one of the plurality of text similarity metrics.

4. The system of claim 1, wherein the plurality of text similarity metrics comprises at least one of:
a difference of token count between the corresponding title and the query;
a difference of string length between the corresponding title and the query;
a per character Levenshtein distance between the corresponding title and the query;
a matching contiguity score based on indices of matched tokens between the corresponding title and the query; or
a starting index of the matched tokens in the corresponding title.

5. The system of claim 1, wherein the plurality of text similarity metrics comprises an asymmetrical matching similarity based on:
N-grams constructed from characters, tokens, or words in the corresponding title and the query; or
a Monge-Elkan similarity between the corresponding title and the query.

6. The system of claim 1, wherein the plurality of text similarity metrics comprises an exact matching similarity based on at least one of:
a number of matching tokens between the corresponding title and the query;
a percentage of tokens matched in the corresponding title; or
a percentage of tokens matched in the query.

7. The system of claim 1, wherein the plurality of text similarity metrics comprises a normalized TF-IDF score based on:
a Boolean term frequency for each token in the query;
an inverse document frequency for each token in the query; and
a cosine normalization performed based on a length of the corresponding title.

8. The system of claim 1, wherein the instructions, when executed by the processor, further cause the processor to train the machine learning model based at least by:
generating a training dataset including training features and training targets based on historical search data and item object data, wherein:
the training features include text similarity features, product metadata, engagement data, and query understanding signals,
the training targets are generated based on a weighted combination of click through rate (CTR), add to cart (ATC) rate and order rate (OR) within a recent time period;
training the machine learning model using the training dataset with a pointwise objective function; and
finetuning at least one model hyperparameter of the machine learning model using an offline evaluation score.

9. A computer implemented method, comprising:
receiving a query including a plurality of tokens;
selecting a plurality of item objects based on the query, wherein each item object of the plurality of item objects has a corresponding title;
obtaining feature data of the plurality of item objects;
ranking the plurality of item objects to generate a ranked list of item objects based at least by:
determining a plurality of text similarity metrics,
generating, for each item object having the corresponding title, similarity scores based on the plurality of text similarity metrics, respectively, wherein each of the similarity scores indicates a text similarity between the corresponding title and the query based on a respective one of the plurality of text similarity metrics, and
executing a machine learning model to the similarity scores of the plurality of item objects based on the feature data of the plurality of item objects to generate the ranked list of item objects; and
providing the ranked list of item objects in response to the query.

10. The computer implemented method of claim 9, wherein the feature data of the plurality of item objects comprises at least one of:
product metadata including price, ratings, and availability for each of the plurality of item objects;
engagement data including click through rate (CTR), add to cart (ATC) rate and order rate (OR) for each item object, each leaf category of item objects, or each item brand; or
query understanding signals including brand extraction, department classification, and category classification of the plurality of item objects.

11. The computer implemented method of claim 9, wherein generating the similarity scores comprises:
performing a plurality of natural language processes on the query and the corresponding title to create a modified query and a modified title, wherein the plurality of natural language processes comprise: tokenization, normalization, lemmatization, accent removal, and stop word removal; and
generating each of the similarity scores to represent a text similarity between the modified query and the modified title based on a respective one of the plurality of text similarity metrics.

12. The computer implemented method of claim 9, wherein the plurality of text similarity metrics comprises at least one of:
a difference of token count between the corresponding title and the query;
a difference of string length between the corresponding title and the query;
a per character Levenshtein distance between the corresponding title and the query;
a matching contiguity score based on indices of matched tokens between the corresponding title and the query; or
a starting index of the matched tokens in the corresponding title.

13. The computer implemented method of claim 9, wherein the plurality of text similarity metrics comprises an asymmetrical matching similarity based on:
N-grams constructed from characters, tokens, or words in the corresponding title and the query; or
a Monge-Elkan similarity between the corresponding title and the query.

14. The computer implemented method of claim 9, wherein the plurality of text similarity metrics comprises an exact matching similarity based on at least one of:
a number of matching tokens between the corresponding title and the query;
a percentage of tokens matched in the corresponding title; or
a percentage of tokens matched in the query.

15. The computer implemented method of claim 9, wherein the plurality of text similarity metrics comprises a normalized TF-IDF score based on:
a Boolean term frequency for each token in the query;
an inverse document frequency for each token in the query; and
a cosine normalization performed based on a length of the corresponding title.

16. The computer implemented method of claim 9, further comprising training the machine learning model based at least by:
generating a training dataset including training features and training targets based on historical search data and item object data, wherein:
the training features include text similarity features, product metadata, engagement data, and query understanding signals,
the training targets are generated based on a weighted combination of click through rate (CTR), add to cart (ATC) rate and order rate (OR) within a recent time period;
training the machine learning model using the training dataset with a pointwise objective function; and
finetuning at least one model hyperparameter of the machine learning model using an offline evaluation score.

17. A non-transitory computer-readable storage medium comprising executable instructions that, when executed by one or more processors of a computing device, cause the one or more processors to:
receive a query including a plurality of tokens;
select a plurality of item objects based on the query, wherein each item object of the plurality of item objects has a corresponding title;
obtain feature data of the plurality of item objects;
rank the plurality of item objects to generate a ranked list of item objects based at least by:
determining a plurality of text similarity metrics,
generating, for each item object having the corresponding title, similarity scores based on the plurality of text similarity metrics, respectively, wherein each of the similarity scores indicates a text similarity between the corresponding title and the query based on a respective one of the plurality of text similarity metrics, and
executing a machine learning model to the similarity scores of the plurality of item objects based on the feature data of the plurality of item objects to generate the ranked list of item objects; and
provide the ranked list of item objects in response to the query.

18. The non-transitory computer-readable storage medium of claim 17, wherein the feature data of the plurality of item objects comprises at least one of:
product metadata including price, ratings, and availability for each of the plurality of item objects;
engagement data including click through rate (CTR), add to cart (ATC) rate and order rate (OR) for each item object, each leaf category of item objects, or each item brand; or
query understanding signals including brand extraction, department classification, and category classification of the plurality of item objects.

19. The non-transitory computer-readable storage medium of claim 17, wherein the plurality of text similarity metrics comprises at least one of:
a difference of token count between the corresponding title and the query;
a difference of string length between the corresponding title and the query;
a per character Levenshtein distance between the corresponding title and the query;
a matching contiguity score based on indices of matched tokens between the corresponding title and the query;
a starting index of the matched tokens in the corresponding title;
an asymmetrical matching similarity between the corresponding title and the query;
an exact matching similarity between the corresponding title and the query; or
a normalized TF-IDF score.

20. The non-transitory computer-readable storage medium of claim 17, wherein the executable instructions, when executed by the one or more processors, further cause the one or more processors to train the machine learning model based at least by:
generating a training dataset including training features and training targets based on historical search data and item object data, wherein:
the training features include text similarity features, product metadata, engagement data, and query understanding signals,
the training targets are generated based on a weighted combination of click through rate (CTR), add to cart (ATC) rate and order rate (OR) within a recent time period;
training the machine learning model using the training dataset with a pointwise objective function; and
finetuning at least one model hyperparameter of the machine learning model using an offline evaluation score.
